(19) United States
(12) Patent Application Publication
(10) Pub. No.: US 2004/0071471 A1
(43) Pub. Date: Apr. 15, 2004

(54) Method and system for pairing a remote control transmitter and receiver

(75) Inventors: Jeffrey Ross Baker, Thousand Oaks, CA (US); Lev Freidin, Simi Valley, CA (US); Larry Stuart Shilkoff, Simi Valley, CA (US); Kenneth E. Johnson, Camarillo, CA (US); Carlos Solis Sanchez, Oxnard, CA (US); James Dexter Tickle, Moorpark, CA (US); David Lee Stallard, Camarillo, CA (US); Michael W. Ambrose, Thousand Oaks, CA (US)

Correspondence Address: BROOKS KUSHMAN P.C., 1000 TOWN CENTER, TWENTY-SECOND FLOOR, SOUTHFIELD, MI, 48075, US

(73) Assignee: Interlink Electronics, Inc., Camarillo, CA

(21) Appl. No.: 10/269,574

(22) Filed: Oct. 10, 2002

(51) Int. Cl. H04B 10/00

(52) U.S. Cl. 398/140

(57) ABSTRACT

A method and system for pairing a remote control transmitter and receiver includes associating an identification (ID) code with the transmitter. The transmitter includes a light generator for generating a light signal in order to perform a primary function which is visually detectable by a human operator. The light generator may be a laser pointer or a status indicator LED. The light generator is modulated to encode the identification code onto the light signal while the light generator is performing the primary function. The receiver includes a light signal detector such as an LED for receiving the light signal from the light generator. The receiver associates itself with the ID code contained in the light signal in order to pair the receiver with the transmitter. By being paired with the transmitter, the receiver acts upon transmitted command signals received from the transmitter.

### BACKGROUND OF THE INVENTION

1. Field of the Invention

The present invention relates to methods and systems for establishing a pairing between a remote control transmitter and receiver.

2. Background Art

Compared to the transmission of remote control signals over infrared light, the transmission of remote control signals over radio waves, i.e., radio-frequency (RF) communication, enables non-directional and relatively long-range remote control. However, these improvements in usability also increase the possibility of interference between remote control devices such as transmitters and receivers. Specifically, a signal transmitted by one transmitter may be received inadvertently by a second nearby receiver. If the transmitted signal is used to control a garage door or gate, for example, then inadvertent reception of the signal could be a security risk. In the case of remote control of equipment such as home entertainment devices and presentation projectors inadvertent reception could cause annoying and embarrassing control actions to occur. In the case of a remote control keyboard, inadvertent reception could even allow eavesdropping of typed text.

Methods are known for preventing inadvertent reception between remote control transmitters and receivers. Such methods allow a receiver to recognize and distinguish between different transmitters; enable a receiver to decide whether a transmission is intended for itself; and establish a pairing between specific transmitters and receivers. These methods have in common an identification (ID) signal or code associated with each pairing. The ID code, which may be a few bits or bytes of information, is transmitted by the transmitter with each normal remote control packet and used by the receiver to match and qualify the transmitted remote control packet.

As remote control transmitters and receivers are often shipped in pre-matched pairs, it is infrequent that users ever need to be concerned with the establishment of a pairing. However, any scenario that involves the replacement of either half of an established pair requires an operator to establish a new pairing. An example scenario is the failure or loss in an established pair of either a transmitter or a receiver. Further, at times, users are required to establish new pairings in order for a receiver to recognize multiple transmitters. For instance, in the case of garage door remote control openers, this requirement arises when multiple transmitters must open the same door. For presentation remote controls this requirement arises when multiple presenters, each of whom would like their own remote control, control the same presentation.

Although ID code transmission and pairing schemes have evolved to avoid simultaneous reception and recognition of a transmission by more than one receiver, it may still be desired to accomplish the converse; that is, the pairing of a single transmitter with multiple receivers. For example, one may wish to use the same transmitter with multiple receivers that are geographically separated enough not to suffer from unintended reception.

For all scenarios, the method of establishing a remote control transmitter/receiver pairing should be as simple as possible. From a remote control user's point of view, the method should also be transparent in that the operator may know that a pairing is being established, but need not know that the devices are exchanging codes or the structure of the codes. Ideally, because the method is likely to be infrequent, it should be memorable and obvious enough not to require a search for a long-lost manual or a telephone call to the customer support center of the remote control manufacturer. From the manufacturer's point of view, the method of establishing a remote control transmitter/receiver pairing should be as low cost as possible. Ideally, the remote control devices require only a few extra components or circuit elements in order to carry out such method.

Several methods are known for establishing the pairing of specific RF remote control transmitters and receivers. Most of these methods center on the technology of garage door openers. An early and simple example of achieving pairing is the use of multiple switches in both the transmitter and receiver as disclosed in U.S. Pat. No. 4,471,408. As disclosed, a set of switches in a transmitter determines an ID code to be transmitted with every command. Likewise, a similar set of switches in the receiver determines which ID code is acceptable. When both sets of switches are set identically the receiver will accept commands from only the specified transmitter. While simple, the number of possible switch combinations limits this method. Also, the establishment of multiple pairings requires multiple sets of switches or some scheme to input and memorize multiple switch settings. Further, such switches tend to be small because of size constraints.

U.S. Pat. No. 5,148,159 discloses a method which enables a transmitter and a receiver to communicate an ID code with minimal operator involvement. As disclosed, the ID code of a base unit receiver is transferred to a transmitter when the two are physically connected together at a communication port. The same receiver ID can be transferred to many transmitters. Likewise, a transmitter can have a provision to store and choose between the codes for several different base units. While straightforward to use, this method requires that the transmitter and the receiver be manufactured with mating connectors even though they will only be used once or infrequently.

Another strategy is to have at least one or both of the transmitter and the receiver enter a “teach” or “learn” mode. In these modes, an ID code is relayed between the transmitter and the receiver and stored for future use. As disclosed in U.S. Pat. No. 5,751,224 every transmitter has a fixed ID code which is transmitted with each transmission. When a receiver is manually put into the learn mode by pressing a switch, the receiver is receptive to registering the next detected ID code. Thereafter, when the receiver compares the ID code of a signal to its registry of known ID codes, commands from registered remote control transmitters may be allowed.

U.S. Pat. No. 4,529,980 discloses the use of optical channels for communicating an RF remote control device ID. As disclosed, an RF receiver generates a new random ID code and transfers it over an infrared link to an RF transmitter. The RF transmitter captures and stores the ID code which thereafter becomes its device ID. This method requires that the RF receiver be induced to transfer the ID code by pressing a mode switch. Also, extra circuit components must be included to provide the infrared link.

### SUMMARY OF THE INVENTION

Accordingly, it is an object of the present invention to provide a method and system for establishing a pairing between a remote control transmitter and receiver which is more simple, transparent, and memorable than known related methods.

It is another object of the present invention to provide a method and system for establishing a pairing between a remote control transmitter and receiver by using existing light generating components of the transmitter to transmit an identification (ID) code from the transmitter to the receiver over an optical short range channel.

It is a further object of the present invention to provide a method and system for establishing a pairing between a remote control transmitter and receiver by modulating a laser pointer of the transmitter to transmit an ID code from the transmitter to the receiver over an optical short range channel.

It is yet another object of the present invention to provide a method and system for establishing a pairing between a remote control transmitter and receiver by modulating a status or transmission indicator such as a light emitting diode (LED) of the transmitter to transmit an ID code from the transmitter to the receiver over an optical short range channel.

It is yet a further object of the present invention to provide a method and system for establishing a pairing between a remote control transmitter and receiver by providing an LED as a light detector and having the LED receive over an optical short range channel from the transmitter a light signal containing the ID code.

In carrying out the above objects and other objects, the present invention provides a remote control system including a transmitter and a receiver. The transmitter has a light generator for generating a light signal in order to perform a primary function which is visually detectable by a human operator. The transmitter further has an identification code. The transmitter modulates the light generator to encode the identification code onto the light signal while the light generator is performing the primary function. The transmitter further has a command signal generator for transmitting a wireless command signal containing the identification code and a command.

The receiver has a light signal detector for receiving the light signal from the light generator of the transmitter. The receiver is operable to become associated with the identification code contained in the light signal such that the receiver acts upon the commands of received command signals containing the identification code.

The light generator may be a laser pointer with the light signal being a laser beam. In this case, the primary function of the laser pointer is to highlight a target with the laser beam. The light generator may be a light emitting diode (LED). In this case, the primary function of the LED is to provide a light signal indicative of status of the transmitter. The wireless command signal may be communicated using radio frequency (RF) or infrared communications.

The light signal detector is preferably an LED. The receiver includes a light pipe associated with the LED for transferring the light signal from the surface of the receiver, upon which the light signal impinges, to the LED. The light signal detector may function in second mode for generating an indicator light signal.

The receiver may include a graphical overlay indicative of instructions for associating the receiver with the identification code of the transmitter. The graphical overlay includes a transparent window which is aligned with the light signal detector of the receiver.

The receiver may be operable to become associated with the identification code contained in the light signal of another transmitter such that the receiver acts upon the commands of received command signals containing either identification code.

Further, in carrying out the above objects and other objects, the present invention provides a method for pairing a remote control transmitter and receiver in which the transmitter has a light generator for generating a light signal in order to perform a primary function which is visually detectable by a human operator. The method includes associating an identification code with the transmitter. The light generator is modulated to encode the identification code onto the light signal while the light generator is performing the primary function. A light signal detector of the receiver is used to receive the light signal from the light generator of the transmitter. The receiver is then associated with the identification code contained in the light signal in order to pair the receiver with the transmitter.

Also, in carrying out the above objects and other objects, the present invention provides another remote control system having a transmitter and a receiver. The transmitter has a command signal generator for wirelessly transmitting a command signal containing at least one identification code and a command. The receiver has an identification code. The receiver is operable for wirelessly receiving the command signal and acting upon the command of the command signal if the at least one identification code of the command signal matches the identification code of the receiver. The receiver further has a light generator for generating a light signal in order to perform a primary function which is visually detectable by a human operator. The receiver modulates the light generator to encode the identification code of the receiver onto the light signal while the light generator is performing the primary function.

The transmitter further has a light signal detector for receiving the light signal from the light generator of the receiver. The transmitter is operable such that additional command signals transmitted by the transceiver contain the identification code of the receiver.

The advantages associated with the present invention are numerous. For instance, the present invention provides a method and system for establishing remote control transmitter/receiver pairing which is more simple, transparent, and memorable than known related methods. The method and system of the present invention add minimal incremental cost as they use existing or readily available remote control device components in order to establish the pairing. Further, the method and system of the present invention are applicable across many types of remote control devices such as for home entertainment devices, home control devices, presentation projectors, computer mice, and computer keyboards.

### BRIEF DESCRIPTION OF THE DRAWINGS

FIG. 1 illustrates a block diagram of a remote control presentation projector system in accordance with the present invention;

FIG. 2 illustrates a circuit diagram of a first embodiment of the optical receiver circuit of the remote control receiver shown in FIG. 1;

FIG. 3 illustrates a circuit diagram of a second embodiment of the optical receiver circuit of the remote control receiver shown in FIG. 1;

FIG. 4 illustrates a top view of the remote control receiver shown in FIG. 1;

FIG. 5 illustrates a cutaway side view of the remote control receiver shown in FIG. 1;

FIG. 6 illustrates a graphical overlay placed on top of the remote control receiver shown in FIG. 1; and

FIG. 7 illustrates a schematic depicting use of the remote control transmitter and receiver in accordance with the present invention.

### DETAILED DESCRIPTION OF THE PREFERRED EMBODIMENT(S)

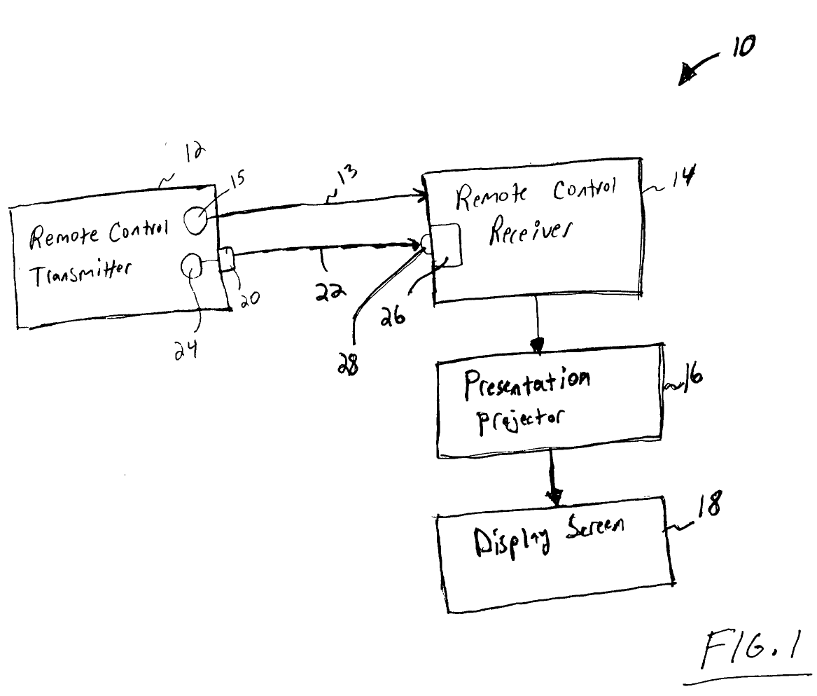

Referring now to FIG. 1, a block diagram of a remote control presentation projector system 10 in accordance with the present invention is shown. System 10 includes a radio frequency (RF) (or infrared) operated remote control transmitter 12 and a receiver 14. Both of transmitter 12 and receiver 14 have at least one associated identification (ID) code. An operator actuates a command button 15 of transmitter 12 in order to transmit a wireless RF command signal 13 from the transmitter to receiver 14 with the end goal of controlling a presentation projector 16. RF command signal 13 includes data indicative of the control command and data indicative of the ID code associated with transmitter 12.

Receiver 14 is either directly connected or wirelessly connected to projector 16. In response to receiving an RF command signal 13 from transmitter 12, the receiver initially compares the ID code of the RF command signal with the ID code of the receiver. If these two ID codes match then receiver 14 knows that it is the intended recipient of RF command signal 13, i.e., transmitter 12 and receiver 14 are paired. Receiver 14 then provides the control command contained in RF command signal 13 to projector 16. Projector 16 then controls a display screen 18 appropriately. If these two ID codes do not match, i.e., transmitter 12 and receiver 14 are not paired, then the receiver disregards the control command contained in RF command signal 13.

Transmitter 12 includes a light generating device 20 such as a laser pointer. The operator typically uses laser pointer 20 for transmitting a laser beam 22 at display screen 18 in order to highlight slides or other displayed material. Laser beam 22 casts a bright red spot on display screen 18 when laser pointer 20 is activated and is pointed towards the display screen. Such laser pointers typically consist of a red laser diode having a narrow, low divergence beam with optical power less than 1 mW. Transmitter 12 further includes a laser pointer button 24 for activating laser pointer 20.

Transmitter 12 is imbued with a sixteen-bit identification (ID) code by either fixing the ID code at the time of manufacture or by having it create and store its own random ID code. By using sixteen bits for the ID code, the probability that two transmitters with identical ID codes will be within range of the same receiver is extremely low. However, a shorter or longer ID code can just as easily be used.

In accordance with the present invention, transmitter 12 transmits the ID code over laser beam 22 while laser pointer 20 is activated. As such, whenever the operator activates laser pointer 20 by pressing laser pointer button 24, laser beam 22 is keyed on and off with a pattern that represents the ID code. This modulation is performed at a rate fast enough for the flicker of a stationary beam spot to be indiscernible by the naked eye.

The modulation of laser beam 22 in order to convey the ID code may be done by using many techniques for encoding data onto a light beam. Preferably, the present invention uses Manchester encoding. In operation, each transmission begins with a header that includes turning laser pointer 20 on for 1280 microseconds then off for 640 microseconds. The header is followed by sixteen bits of data representing the ID code with high bits being transmitted by turning laser pointer 20 on for 640 microseconds then off for 640 microseconds. Similarly, a low bit is transmitted by turning laser pointer 20 off for 640 microseconds and then on for 640 microseconds.

With this scheme the ID code is transmitted in under 25 milliseconds. Transmitter 12 repeatedly transfers the ID code every 25 milliseconds while laser pointer 20 is activated. Other pulse lengths and timings will work equally as well as long as the pulse lengths are short enough not to be easily noticed but not so short as to exceed the switching speed of the laser power supply.

In order to receive the ID code from laser pointer 20 of transmitter 12, receiver 14 includes an optical receiver circuit 26. Optical receiver circuit 26 includes a light detector 28. Preferably, light detector 28 is a light emitting diode (LED). An LED is a device that is normally used to emit light as opposed to receiving light. Using an LED as light detector 28 is inexpensive compared to using a more typical optoelectronic component such as a photodiode or a phototransistor. LED 28 is also much less sensitive than such photo detecting devices. However, the lack of sensitivity is an advantage because it guarantees that none but the most directed light such as light beam 22 from laser pointer 20 will generate an adequate received signal. As such, only when transmitter 12 is brought into proximity with receiver 14 and laser beam 22 is shined directly onto LED 28 of receiver 14 can the receiver distinguish the ID code encoded onto the laser beam.

Upon receiver 14 distinguishing the ID code encoded onto laser beam 22 of transmitter 12, the receiver associates itself with this ID code. For instance, receiver 14 may replace any existing associated ID code with the ID code encoded onto laser beam 22. By associating itself with the ID code encoded onto laser beam 22 of transmitter 12, receiver 14 becomes paired with the transmitter. As such, receiver 14 now functions to control presentation projector 16 in response to receiving an RF command signal 13 from transmitter 12 while disregarding the control commands of RF command signals from other transmitters.

In a similar manner, receiver 14 can distinguish the ID codes from multiple transmitters, and associate itself with all of the multiple transmitters. To accomplish the multiple associations, receiver 14 must store the ID codes, and then compare each received ID code with the stored ID codes. If a match is found, receiver 14 uses the control command. The means for storing the ID codes is to write it into non-volatile memory, such as is commonly available within the types of micro-controllers used in remote control transmitters and receivers.

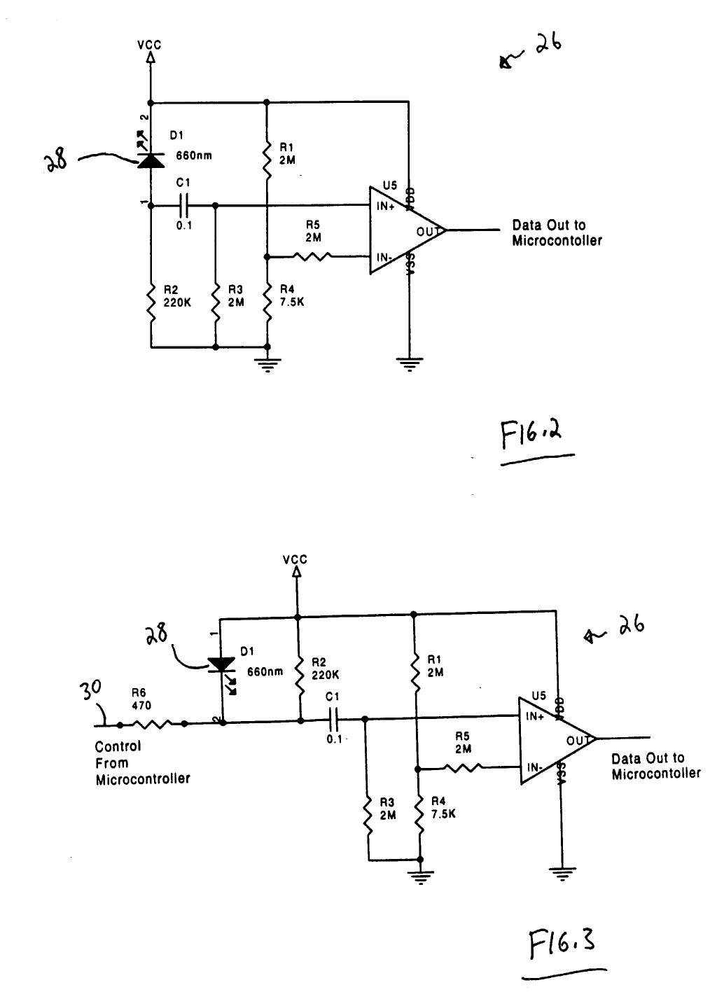

Referring now to FIG. 2, a circuit diagram of a first embodiment of optical receiver circuit 26 is shown. This embodiment employs the technique of using a reversed biased LED as a light receiver. The resistance and capacitance values shown in FIG. 2 are in ohms and microfarads, respectively. LED 28 is reversed biased so that photons of appropriate energy allow small electrical currents to flow. These small currents appear as voltage fluctuations across resistor R2 which are AC coupled to an operational amplifier U5 through capacitor C1. Amplifier U5 is configured essentially as a comparator, with the inverting input referenced to just above the signal thresholds for noise, any detected ambient light, and the DC offset of the amplifier itself. Via the OUT port of amplifier U5, optical receiver circuit 26 outputs a voltage near Vcc when laser beam 22 shines on LED 28 and zero volts otherwise. Several other circuit configurations could yield the same result. In particular, amplifier U5 is unnecessary if using a micro-controller with a built-in comparator.

Referring now to FIG. 3, a circuit diagram of a second embodiment of optical receiver circuit 26 is shown. This embodiment employs the technique of using an LED in photovoltaic mode as a light receiver. The resistance and capacitance values shown in FIG. 3 are also in ohms and microfarads, respectively. In the embodiment of FIG. 3, LED 28 can be operated alternatively as an indicator and as a light receiver. This capability of dual operation is advantageous when only a single LED is desired for aesthetic or space considerations.

In optical receiver circuit 26 shown in FIG. 3, LED 28 is operated in photovoltaic mode where photons of appropriate energy cause small voltage differences. As in the technique described with reference to FIG. 2, these voltage fluctuations are AC coupled to an operational amplifier U5. Amplifier U5 is configured as a comparator. In order to switch between operation as an indicator and operation as a light receiver, a control line 30 is provided. When control line 30 is grounded by a control circuit, such as by a pin on a micro-controller, LED 28 lights. When the control circuit is placed into a high-impedance or open-circuit mode, such as is commonly possible with pins on a micro-controller, LED 28 functions as a light receiver. Several other circuit configurations could yield the same result.

In the circuit configurations shown in FIGS. 2 and 3, LED 28 is chosen to maximize sensitivity to laser beam 22. One of many possible lasers is model number LM761-A2 manufactured by Excel Scientech of Taipei, Taiwan, which has a wavelength of 650 nanometers. Maximizing sensitivity to this laser is accomplished by choosing an LED with a bandgap energy lower than the laser photon energy. In practice, this will be the case if the LED output wavelength is at least slightly longer than the laser output wavelength. An example of an LED suitable to receive light from the 650 nanometer laser is Panasonic LNJ208R8ARA which emits light centered at 660 nanometers with a spectral width of 10 nanometers. In principle, any laser and LED pair can be used as long as the LED wavelength is similar to or longer than the laser wavelength.

Yet another alternative to the optical receiver circuits shown in FIGS. 2 and 3 is a dual LED in one package. This could allow an indicator and the light receiver to function simultaneously while still minimizing space. An example of an appropriate device is Fairchild part number QTLP600C-74 which has a 660 nanometer red LED and a 565 nanometer green LED in the same package.

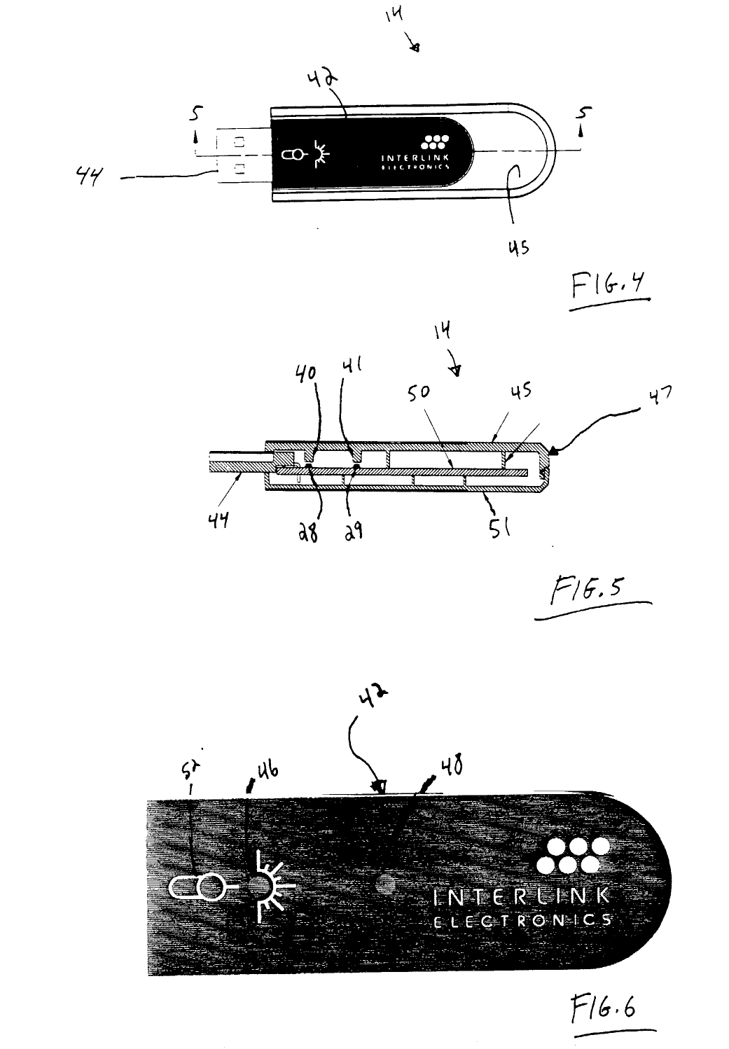

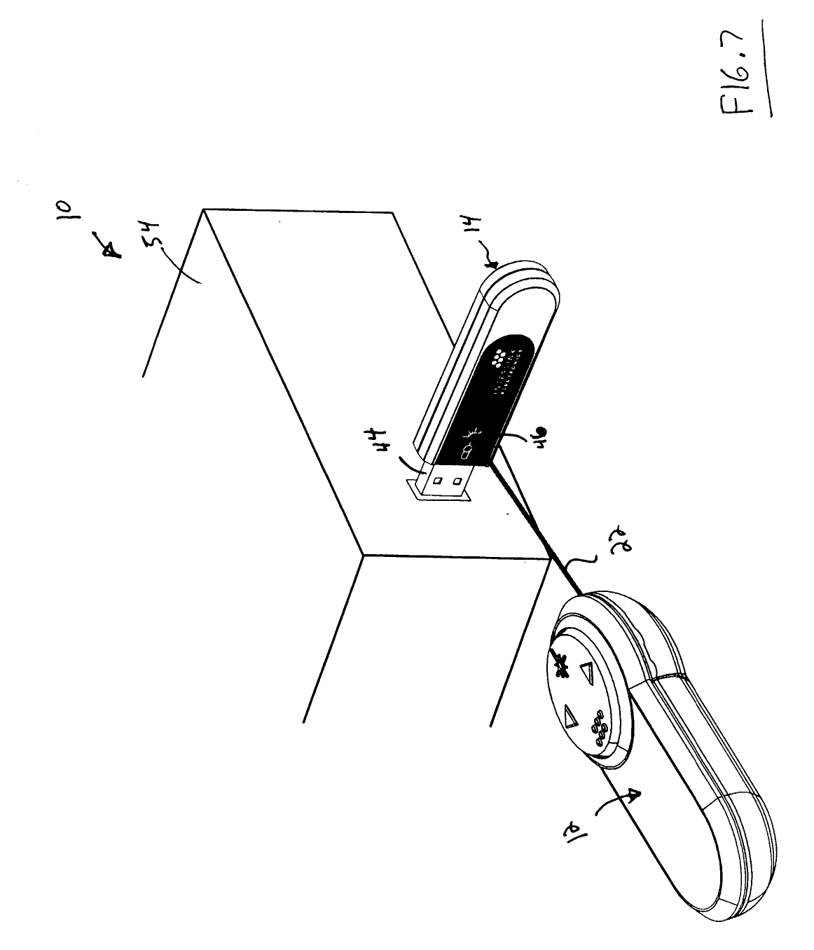

Referring now to FIGS. 4, 5, and 6, in addition to the use of an LED as an inexpensive light detector 28, a light pipe 40 and an instructive graphical display 42 are both associated with receiver 14 and contribute to the aspects of the present invention. FIG. 4 illustrates a view of receiver 14 from above and FIG. 5 illustrates a cutaway view of the receiver from the side. Receiver 14 includes a USB connector 44 for plugging the receiver into the USB port of a computer (presentation projector, etc.). On a top surface 45 of receiver housing 47 is opaque graphic overlay 42. Overlay 42 has two transparent windows 46 and 48. Laser beam 22 is shown through the left transparent window 46 for reception by optical receiver LED 28. The right transparent window 48 is a status indicator that passes light from a status or transmission indicator LED 29.

As shown in FIG. 5, LEDs 28 and 29 are surface mounted components that are soldered flat onto a printed circuit board 50. Circuit board 50 is held within top surface 45 and bottom surface 51 of receiver housing 47 by mounting posts and the like. For clarity, several components have been omitted from the view shown in FIG. 5. Such components include the RF receiver circuitry, a micro-controller, and supporting components.

LEDs 28 and 29 reside on circuit board 50 and, as such, the LEDs are recessed from the outer surface of receiver housing 47. Light pipe 40 is used to ensure that light from laser pointer 20 is easily directed into optical receiver LED 28. A second light pipe 41 is associated with LED 29 for enabling light to be transmitted from LED 29 to the exterior of receiver body 47. Light pipes 40 and 41 are constructed by molding the entire receiver housing 47 from transparent plastic and then spray painting the exterior everywhere except the light pipe entrances. The light pipe entrances are then aligned with transparent windows 46 and 48 of overlay 42 when the overlay is positioned on top surface 45 of receiver housing 47. Light pipes 40 and 41 could also be constructed by other methods such as inserting a separately molded transparent piece. Alternately, light coupling to optical receiver LED 28 can also be achieved by mounting this LED so that it protrudes through a hole in receiver housing 47.

LED 29 of receiver 14 is provided as a power and status indicator. LED 29 blinks at a specific first rate while receiver 14 is properly powered. LED 29 blinks at a second easily distinguishable rate while receiver 14 receives data such as RF remote control signals from transmitter 12. After a successful transfer of an ID code from transmitter 12 to receiver 14, LED 29 provides feedback to the operator by remaining lit steadily for a period of time such as three seconds. Other schemes for multiple status indication functions using the single indicator LED are also possible.

As described above, graphical overlay 42 includes an image printed onto the overlay. Overlay 42 is adhered to top surface 45 of receiver housing 47. Overlay 42 is opaque except for two transparent spots (i.e., left and right transparent windows 46 and 48). Left transparent window 46 is provided for the optical receiver LED 28 and right transparent window 48 is provided for indicator LED 29. Icon 52 around left window 46 depicts the programming process by showing transmitter 12, laser beam 22, and a universal pictograph of laser light directly on the target. The self-explanatory and highly instructive nature of icon 52 obviates the need for operators to retain a manual or to memorize the programming procedure. On the right side, overlay 42 includes a corporate logo.

Referring now to FIG. 7, a diagram illustrating use of transmitter 12 and receiver 14 is shown. Receiver 14 is plugged into a computer 54 (such as presentation projector 16 or a personal computer). When the operator presses laser pointing button 24, laser beam 22 shines forward from laser pointer 20 of transmitter 12. When brought near receiver 14, laser beam 22 is easily shined onto the receiver at transparent window 46 for receipt by optical receiver LED 28. In a short fraction of a second, the ID code is transferred from transmitter 12 to receiver 14 via laser beam 22. Second LED 29 gives the operator visual feedback of a successful transfer operation.

There are multiple alternatives for configuring pairs of RF remote control transmitters and receivers at time of manufacture. One option is to program each receiver 14 with its paired transmitter 12 using laser pointer 20 as described above. However, this causes the logistical problem within the factory that forever after the pair must be maintained. That is, they must finish manufacture together, must pass inspection together, must be stocked together; and most importantly, must be shipped together. A better option would enable any receiver to be shipped with any transmitter.

One approach to enabling any receiver to be shipped with any transmitter would be to require users to program receiver 14 themselves. Another approach would be to reserve a small subset of possible ID codes for manufacturer use, which, when stored in receiver 14, can later indicate to the receiver that it should accept and store the ID code contained in the next detected RF command signal. For example, the codes 0 to 15 out of a possible range of 0 to 65,535 can be reserved for manufacture use. During manufacture, each receiver is tested by being programmed and exercised using a transmitter having one of the factory reserved ID codes. Each receiver is then finished, stored, etc., without regard to which transmitter it will ultimately share a package. Transmitters are likewise finished, stored, etc., but with one of the usual non-reserved ID codes. Then, at time of packaging, any transmitter may be shipped with any receiver.

When powered by being inserted into a computer 54, presentation projector 16, and the like, receiver 14 tests for the presence of one of the factory reserved ID codes. If a factory reserved ID code is found, then receiver 14 enters a mode where the ID code contained in the next detected RF command signal will be recorded as if it were programmed by the laser process of the present invention as described above. The newly imprinted ID code overwrites the factory ID code so that this procedure is not repeated. In this way, the manufacturing logistics remain simple and out-of-the-box usability is preserved. Subsequently, receiver 14 can be paired with a second transmitter by detecting a modulated laser beam containing the ID code from the second transmitter as described above. In this event, receiver 14 can be programmed to become paired solely with the second transmitter or can be paired with both the original and the second transmitter.

The above-described laser method for establishing a pairing between remote control transmitters and receivers has several benefits. This method of transferring remote control ID codes is inherently short range because at distances greater than ⅓ of a meter it is extremely difficult to aim laser beam 22 of laser pointer 20 onto optical receiver LED 28. This means that inadvertent programming is virtually impossible. The incremental cost for transmitter 12 is negligible because a laser already exists primarily as a pointing device. The incremental cost to receiver 14 is small because the method of using an LED as a light receiver is inexpensive and requires minimal extra circuitry. With the addition of factory reserved ID codes, manufacturing logistics remain simple.

From an operator's point of view, the method of pairing a remote control transmitter and receiver is extremely simple. No switches need be configured, no special buttons need be pressed, and neither device must be placed into a special mode. Furthermore, the method is extremely memorable in the sense that users cannot readily forget how to perform a pairing which is also insured by graphic overlay 42.

In another embodiment of the present invention, remote control transmitter 12 conveys the ID code by modulating a different type of light generating device 20 such as an LED instead of a laser pointer. As is often the case with presentation remote control transmitters, LED 20 can be provided primarily as a transmission indicator. The two functions (status/power indicator and ID code transmitter) occur simultaneously by switching indicator LED 20 fast enough to be unperceivable to the operator's eye. Because the optical signal from an LED 20 is weaker than a laser signal from a laser pointer, transmitter 12 must be brought even more close to receiver 14 in order to transfer the optical signal from LED 20 of transmitter 12 to optical receiver LED 28 of receiver 14. The optical receiver circuits shown in FIGS. 2 and 3 may be used by receiver 14 with this embodiment.

Transmitting the ID code by modulating an LED instead of a laser pointer also enables another embodiment of the present invention. In this embodiment, the roles of transmitter 12 and receiver 14 in the context of ID code transmission/reception are reversed. Receiver 14 is factory programmed with an ID code. Receiver 14 contains an LED to transmit the ID code. This same LED, such as status indicator LED 29, can also simultaneously act as an indicator light as is often found on such devices to indicate power or signal reception. Transmitter 12 contains an optical receiver circuit such as shown in FIGS. 2 and 3 in order to receive the optical signal from LED 29 of receiver 14. In this embodiment, instructive graphical icons can be provided on both RF remote control transmitter 12 and receiver 14.

These alternate embodiments retain the advantages of the preferred embodiment. That is, incremental cost to implement them is low because they use existing components; they are extremely easy to use; and their method of use is memorable and obvious form the devices themselves.

Thus, it is apparent that there has been provided in accordance with the present invention, a method and system for establishing a pairing between a remote control transmitter and receiver that fully satisfy the objects, the advantages, and the aims described above. While embodiments of the present invention have been illustrated and described, it is not intended that these embodiments illustrate and describe all possible forms of the invention. Rather, the words used in the specification are words of description rather than limitation, and it is understood that various changes may be made without departing from the spirit and scope of the present invention.

What is claimed is:

1. A remote control system comprising:
a transmitter having a light generator for generating a light signal in order to perform a primary function which is visually detectable by a human operator, the transmitter further having an identification code, wherein the transmitter modulates the light generator to encode the identification code onto the light signal while the light generator is performing the primary function, the transmitter further having a command signal generator for transmitting a wireless command signal containing the identification code and a command; and
a receiver having a light signal detector for receiving the light signal from the light generator of the transmitter, wherein the receiver is operable to become associated with the identification code contained in the light signal such that the receiver acts upon the commands of received command signals containing the identification code.

2. The system of claim 1 wherein:
the light generator is a laser pointer and the light signal is a laser beam.

3. The system of claim 2 wherein:
the primary function of the laser pointer is to highlight a target with the laser beam.

4. The system of claim 1 wherein:
the light generator is a light emitting diode (LED).

5. The system of claim 4 wherein:
the primary function of the LED is to provide a light signal indicative of the status of the transmitter.

6. The system of claim 1 wherein:
the wireless command signal is an radio frequency (RF) command signal.

7. The system of claim 1 wherein:
the wireless command signal is an infrared command signal.

8. The system of claim 1 wherein:
the light signal detector is a light emitting diode (LED).

9. The system of claim 8 wherein:
the receiver includes a light pipe associated with the LED for transferring the light signal from the surface of the receiver to the LED.

10. The system of claim 1 wherein:
the light signal detector functions in second mode for generating an indicator light signal.

11. The system of claim 1 wherein:
the receiver includes a graphical overlay indicative of instructions for associating the receiver with the identification code of the transmitter.

12. The system of claim 11 wherein:
the instructions of the graphical overlay include a transparent window which is aligned with the light signal detector of the receiver.

13. The system of claim 1 wherein:
the receiver is operable to become associated with the identification code contained in the light signals of multiple transmitters such that the receiver acts upon the commands of received command signals containing identification codes from any of the multiple transmitters.

14. A method for pairing a remote control transmitter and receiver, the transmitter having a light generator for generating a light signal in order to perform a primary function which is visually detectable by a human operator, the method comprising:
associating an identification code with the transmitter;
modulating the light generator to encode the identification code onto the light signal while the light generator is performing the primary function;
using a light signal detector of the receiver to receive the light signal from the light generator of the transmitter; and
associating the receiver with the identification code contained in the light signal in order to pair the receiver with the transmitter.

15. The method of claim 14 wherein:
the light generator is a laser pointer and the light signal is a laser beam.

16. The method of claim 14 wherein:
the light generator is a light emitting diode (LED).

17. The method of claim 14 wherein:
the light signal detector is a light emitting diode (LED).

18. A remote control system comprising:
a transmitter having a command signal generator for wirelessly transmitting a command signal containing at least one identification code and a command;
a receiver having an identification code, the receiver operable for wirelessly receiving the command signal and acting upon the command of the command signal if the at least one identification code of the command signal matches the identification code of the receiver, the receiver further having a light generator for generating a light signal in order to perform a primary function which is visually detectable by a human operator, wherein the receiver modulates the light generator to encode the identification code of the receiver onto the light signal while the light generator is performing the primary function;
the transmitter further having a light signal detector for receiving the light signal from the light generator of the receiver, wherein the transmitter is operable such that additional command signals transmitted by the transceiver contain the identification code of the receiver.

19. The system of claim 18 wherein:
the light generator is a light emitting diode (LED).

20. The system of claim 18 wherein:
the light signal detector is a light emitting diode (LED).
